(19) United States
(12) Patent Application Publication
(10) Pub. No.: US 2010/0319982 A1
(43) Pub. Date: Dec. 23, 2010

(54) ELECTROMAGNETIC WAVE SHIELDING SUBSTRATE

(76) Inventors: Won Woo Cho, Busan (KR); Dek Gin Yang, Chungcheongbuk-do (KR); Jung Soo Kim, Gyunggi-do (KR); Hyung Ho Kim, Incheon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/650,477

(22) Filed: Dec. 30, 2009

(30) Foreign Application Priority Data
Jun. 23, 2009 (KR) 10-2009-0056001

(51) Int. Cl. H01R 4/00

(52) U.S. Cl. 174/376

(57) ABSTRACT

Disclosed herein is an electromagnetic wave shielding substrate including an electromagnetic bandgap structure which is formed along the edge thereof in order to prevent electromagnetic waves from being emitted therefrom. The electromagnetic wave shielding substrate can effectively prevent the emission of electromagnetic waves.

### CROSS REFERENCE TO RELATED APPLICATION

This application claims the benefit of Korean Patent Application No. 10-2009-0056001, filed Jun. 23, 2009, entitled “Substrate shielding electromagnetic wave”, which is hereby incorporated by reference in its entirety into this application.

### BACKGROUND OF THE INVENTION

1. Technical Field

The present invention relates to a substrate having a structure preventing the emission of electromagnetic waves.

2. Description of the Related Art

Recently, with the rapid advancement of technologies and services related to wired and wireless broadcasts and communications, the expectation level of users with respect to products has been becoming higher. In order to meet expectations, products are being miniaturized, sped up and are becoming wider in bandwidth. Concordantly, since clock frequency is included in a range of GHz due to the increase in operation speed, problems with power integrity (PI), signal integrity (SI) and electromagnetic interference (EMI) attributable to simultaneous switching noise (SSN) occurring from various on/off chips or packages, such as digital blocks, placed in multilayered PCBs has been becoming important issues in the design of PCBs.

Simultaneous switching noise (SSN), which is known as delta-I noise or ground bounce noise, is a serious noise source of multilayered PCBs. SSN is generated by time-varying current which is rapidly changed in high-speed digital circuits. The SSN generated between a power layer and a ground layer influences adjacent signal lines, thus causing electromagnetic radiation at the edge of a PCB as well as influencing signal integrity (SI).

Therefore, as one of the general methods of solving the problem with the EMI of a PCB itself in a high-speed digital system, a method of forming vias in the outer frame of the PCB is proposed. However, this method is problematic in that the target frequency of the vias formed in the outer frame of the PCB is determined by the intervals between the vias, and the intervals therebetween are decreased depending on high frequency, thus to increasing production costs.

### SUMMARY OF THE INVENTION

Accordingly, the present invention has been made to solve the above problems, and the present invention provides a substrate having a structure preventing the emission of electromagnetic waves.

An aspect of the present invention provides an electromagnetic wave shielding substrate including an insulation layer and a circuit layer, including: an electromagnetic bandgap structure formed along an edge of the substrate in order to prevent electromagnetic waves from being emitted therefrom, wherein the electromagnetic bandgap structure includes a conductive layer including a plurality of conductive plates and a metal layer which is disposed under or over the conductive layer and includes stitching patterns, each of which serves to electrically connect a first conductive plate with a second conductive plate.

In the electromagnetic wave shielding substrate, the band gap structure may further include: an insulation layer interposed between the conductive layer and the metal layer; a first via penetrating the insulation layer and electrically connecting the first conductive plate with the stitching pattern; and a second via penetrating the insulation layer and electrically connecting the second conductive plate with the stitching pattern.

The plurality of conductive plates may be electrically connected with each other through the stitching patterns.

The conductive layer may be a power layer or a ground layer.

The electromagnetic wave shielding substrate may further include: electromagnetic wave shielding vias formed along an edge of the substrate.

Each of the electromagnetic wave shielding vias may penetrate the conductive plate and the metal layer.

The electromagnetic wave shielding vias are spaced apart from the conductive plate and the metal layer with clearances provided therebetween.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view showing an electromagnetic wave shielding substrate according to an embodiment of the present invention;

FIG. 2 is a schematic enlarged perspective view showing the A region of the electromagnetic wave shielding substrate shown in FIG. 1;

FIG. 3 is a sectional view of the A region taken along the line I-P in FIG. 2; and

FIG. 4 is a plan view of the A region shown in FIG. 2.

### DESCRIPTION OF THE PREFERRED EMBODIMENTS

Hereinafter, a preferred embodiment of the present invention will be described in detail with reference to the attached drawings. Throughout the accompanying drawings, the same reference numerals are used to designate the same or similar components, and redundant descriptions thereof are omitted. In the following description, the terms “upper”, “lower” and the like are used to differentiate a certain component from other components, but the configuration of such components should not be construed to be limited by the terms.

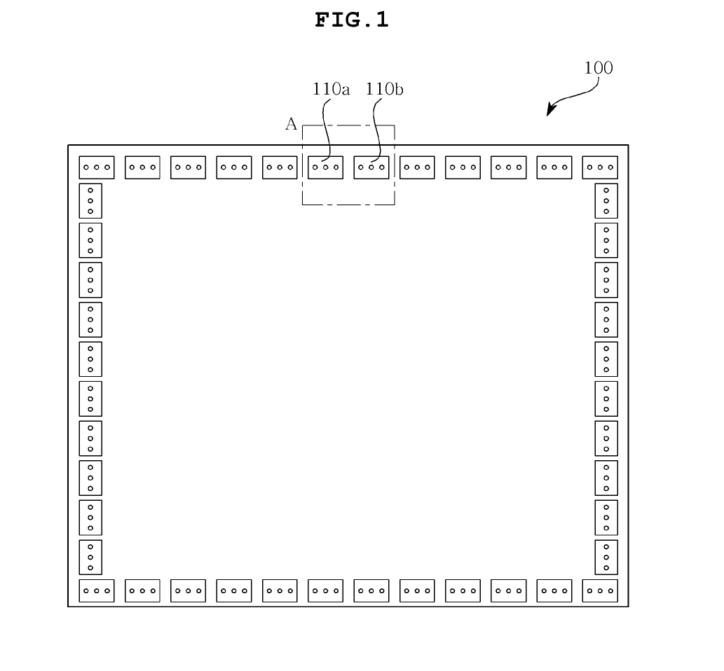

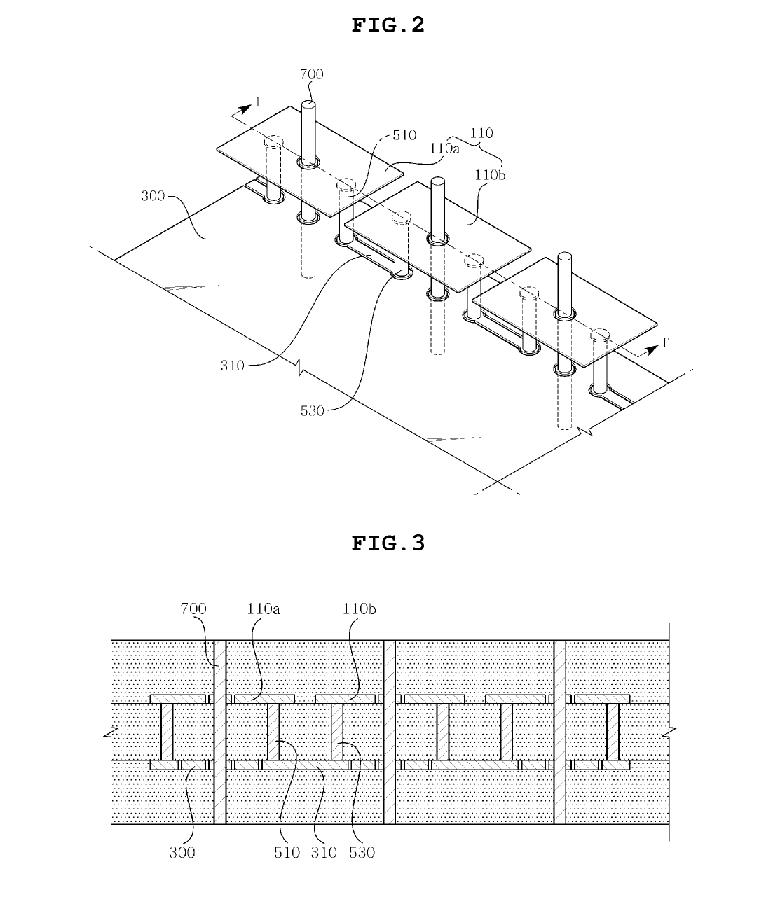

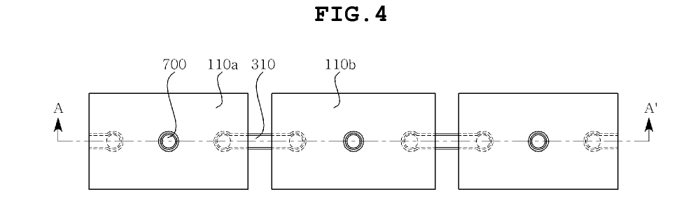

FIG. 1 is a plan view showing an electromagnetic wave shielding substrate according to an embodiment of the present invention, FIG. 2 is a schematic enlarged perspective view showing the A region of the electromagnetic wave shielding substrate shown in FIG. 1, FIG. 3 is a sectional view of the A region taken along the line I-I′ in FIG. 2, and FIG. 4 is a plan view of the A region shown in FIG. 2.

As shown in FIG. 1, an electromagnetic wave shielding substrate according to an embodiment of the present invention includes an electromagnetic bandgap structure formed along the edge of a substrate in order to prevent electromagnetic waves from being emitted therefrom.

Here, the substrate includes an insulation layer made of an electrical insulating material and a circuit layer for transmitting electrical signals, and the term “substrate” may be used to refer to a printed circuit board as well as a semiconductor substrate. In this embodiment, the substrate may be a printed circuit board for mounting thereon an electronic device, which emits electromagnetic waves. The insulation layer may be made of a polymer resin, for example, an epoxy resin, or may be made of epoxy prepreg. The circuit layer may be made of a metal having good electroconductivity, such as gold (Au), silver (Ag), copper (Cu), nickel (Ni) or the like.

The electromagnetic bandgap structure is formed along the edge of the substrate in order to prevent electromagnetic waves from being emitted from the substrate to the outside. This electromagnetic bandgap structure include a conductive layer 110 including a plurality of conductive plates and a metal layer 300 which is disposed under or over the conductive layer 110 and includes stitching patterns 310, each of which serves to electrically connect a first conductive plate 110a with a second conductive plate 110b.

In this case, in FIG. 2, the insulation layer interposed between the conductive layer 110 and the metal layer 300 is not shown in order to clearly illustrate the electromagnetic bandgap structure. The conductive layer 110 may be made of an electroconductive metal, such as gold, silver, copper or the like. The conductive layer 110 may be a power layer or ground layer formed on a printed circuit board. This conductive layer 110 includes the plurality of conductive plates separated from each other. Although the conductive layer 110 may include only the conductive plates separated from each other, it may further include peripheral plates (not shown) which cover the conductive plates with clearances provided between the conductive plates.

The conductive plates are separated and insulated from each other on the conductive layer 110, but are electrically connected to each other through the stitching patterns 310. That is, referring to FIG. 2, the first conductive plate 110a is connected to the second conductive plate 110 through a first via 510→a stitching pattern 310→a second via 530. The first via 510, stitching pattern 310 and second via 530 formed between the first conductive plate 110a and the second conductive plate 110b may be called “a stitching via”. All of the conductive plates formed on the conductive layer 110 are electrically connected with each other through the stitching vias.

In this embodiment, conductive plates are exemplified to have only a rectangle, but they may have a variety of different shapes, such as a circle, a triangle, a hexagon and the like. Therefore, the present invention is not limited to the shapes of the conductive plates shown in the drawings. Further, the conductive plates do not need to have the same sizes as each other, and their sizes may differ. Furthermore, all of the conductive plates do not need to be flush with each other, and the conductive plates formed on different layers may be connected to each other through the stitching vias. That is, in FIG. 3, a four-layered substrate is exemplified, but the present invention is not limited thereto and may be a double-sided substrate or an eight-layered substrate.

The metal layer 300 includes the stitching patterns 310. Like the conductive layer 110, the metal layer 300 may be made of an electroconductive metal, such as gold, silver, copper or the like.

Here, although the metal layer 300 may include just the stitching patterns 310 separated from each other, it may further include peripheral parts (not shown) for covering the stitching patterns 310 with clearances provided between the stitching patterns 310. In this case, the peripheral parts are completely electrically insulated from the stitching patterns 310. The peripheral parts can serve as a ground layer or a power layer.

In this case, one end of the stitching pattern 310 is electrically connected with the lower land of the first via 510, and the other end of the stitching pattern 310 is electrically connected with the lower land of the second via 530. The first via 510 penetrates the insulation layer, and is connected between an upper land formed on the first conductive plate 110a and a lower land formed on the metal layer 300. That is, the first conductive plate 110a is electrically connected with the stitching pattern 310 through the first via 510. Meanwhile, the second via 530 penetrates the insulation layer, and is connected between an upper land formed on the second conductive plate 110b and a lower land formed on the metal layer 300. That is, the second conductive plate 110b is electrically connected with the stitching pattern 310 through the second via 530.

The first via 510 or the second via 530 may be a plated layer formed on the inner wall of a via hole formed in the insulation layer or a conductive filler (plated filler or conductive paste) charging a via hole formed in the insulation layer.

In this embodiment, the stitching pattern 310 is embodied as a linear stitching to pattern, but a curved stitching pattern, preferably, a spiral stitching pattern, may be used as the stitching pattern 310. More generally, the stitching pattern 310 for connecting the lower land of the first via 510 with the lower land of the second via 530 may have a spiral pattern, the electrical connection length of which is longer than that of a stitching pattern for connecting the lower land of the first via 510 with the upper land of the second via 530. In this case, all of the stitching patterns 310 do not need to have the same shapes as each other, and they may have a variety of different shapes.

In the above-mentioned bandgap structure, each of the first vias 510, second vias 530 and stitching patterns provides inductance, and each of the conductive layer 110 and metal layer 300 provides capacitance, thus preventing the emission of electromagnetic waves.

Meanwhile, the electromagnetic wave shielding substrate 100 according to the embodiment of the present invention may further include electromagnetic wave shielding vias 700. The electromagnetic wave shielding vias 700 may be formed such that they completely or partially penetrate the substrate in the thickness direction thereof. In this case, as the distance between the electromagnetic wave shielding vias 700 decreases, the electromagnetic wave emission prevention effect increases.

The electromagnetic wave shielding vias 700 penetrate the conductive plate and the metal layer 300, and are spaced apart from the conductive plate and the metal layer 300 with clearances provided therebetween.

As described above, an electromagnetic wave shielding substrate according to the present invention can effectively prevent the emission of electromagnetic waves because it includes an electromagnetic bandgap structure formed along the edge thereof.

Further, an electromagnetic wave shielding substrate according to the present invention is advantageous in that an electromagnetic wave emission prevention effect can be maximized by combining an electromagnetic bandgap structure with electromagnetic to wave shielding vias.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An electromagnetic wave shielding substrate including an insulation layer and a circuit layer, comprising:
an electromagnetic bandgap structure formed along an edge of the substrate in order to prevent electromagnetic waves from being emitted therefrom,
wherein the electromagnetic bandgap structure comprises a conductive layer including a plurality of conductive plates and a metal layer which is disposed under or over the conductive layer and includes stitching patterns, each of which serves to to electrically connect a first conductive plate with a second conductive plate.

2. The electromagnetic wave shielding substrate according to claim 1, wherein the band gap structure further comprises:
an insulation layer interposed between the conductive layer and the metal layer;
a first via penetrating the insulation layer and electrically connecting the first conductive plate with the stitching pattern; and
a second via penetrating the insulation layer and electrically connecting the second conductive plate with the stitching pattern.

3. The electromagnetic wave shielding substrate according to claim 1, wherein the plurality of conductive plates is electrically connected with each other through the stitching patterns.

4. The electromagnetic wave shielding substrate according to claim 1, wherein the conductive layer is a power layer or a ground layer.

5. The electromagnetic wave shielding substrate according to claim 1, further comprising: electromagnetic wave shielding vias formed along an edge of the substrate.

6. The electromagnetic wave shielding substrate according to claim 5, wherein each of the electromagnetic wave shielding vias penetrates the conductive plate and the metal layer.

7. The electromagnetic wave shielding substrate according to claim 6, wherein the electromagnetic wave shielding vias are spaced apart from the conductive plate and the metal layer with clearances provided therebetween.
